(19) United States
(12) Patent Application Publication
(10) Pub. No.: US 2010/0089612 A1
(43) Pub. Date: Apr. 15, 2010

(54) Electrical connection element of packaging substrate

(75) Inventor: Shih-Ping Hsu, Sinfong Township (TW)

Correspondence Address: BACON & THOMAS, PLLC, 625 SLATERS LANE, FOURTH FLOOR, ALEXANDRIA, VA, 22314-1176, US

(73) Assignee: Phoenix Precision Technology Corporation, Hsinchu (TW)

(21) Appl. No.: 12/285,815

(22) Filed: Oct. 15, 2008

(51) Int. Cl. H01B 5/00

(52) U.S. Cl. 174/126.2

(57) ABSTRACT

An electrical connection element of packaging substrate is disclosed. Wherein a plurality of conductive pads and a solder mask are formed on the surface of the packaging substrate, and a plurality of openings is formed in the solder mask to expose the conductive pads covered there beneath. The electrical connection element formed on the conductive pad comprises a core layer, a first covering layer and a second covering layer. The first covering layer covers the core layer, and the density of the first covering layer is higher than the density of the core layer. The second covering layer covers the first covering layer.

### BACKGROUND OF THE INVENTION

1. Field of the Invention

The present invention relates to an electrical connection element of packaging substrate, and particularly relates to an electrical connection element which enables the miniaturization of the packaging substrate.

2. Description of Related Art

As the electronics industry develops rapidly, the technology of semiconductor packaging accordingly moves towards integration and miniaturization, such as Flip-Chip Ball Grid Array (BGA) packaging. In those Flip-Chip Ball Grid Array packaging, wire bonding is not used to connect electrode pads on the active surface of a chip with a packaging substrate, but instead solder bumps are employed to connect with the packaging substrate directly. Therefore, the density of the electric circuit can be increased and the electrical characters of the Flip-Chip Ball Grid Array packaging can both be improved.

The connection of flip-chip is one kind of area array connection, thus the flip-chip package can be applied to structures with ultra-high density. The connection of flip-chip includes steps of: forming solder bumps on the electrode pads locating on the active surface of the chip, performing alignment and connecting the active surface of the chip with a packaging substrate, then reflow soldering to form solder bumps by the surface tension. Thus, the electrical connection between the chip and the packaging substrate is provided. Such connecting structure has no limitations on the number of the bonding wires, which is also proper to the multi-pins package, and the electrical character is largely increased because of the shortening of the connection path.

Referring to FIG. 1, a conventional flip-chip ball grid array package is shown, which comprises a packaging substrate 10 and a chip 15. A plurality of bump pads 111 is formed on the top surface 10a of the packaging substrate 10, a plurality of ball pads 112 is formed on the bottom surface 10b, and the solder masks 12a and 12b are formed separately on the top surface 10a and the bottom surface 10b of the packaging substrate 10, wherein a plurality of openings 121a and 121b is formed in the solder masks 12a and 12b to expose the bump pads 111 and the ball pads 112. A plurality of electrode pads 151 is located on the active surface of the chip 15, which is electrically connected to the bump pads 111 located on the top surface 10a of the packaging substrate 10 through the electrical connection elements 13 (e.g. solder bumps). Besides, an under-fill 16 can be injected to fill the interval between the packaging substrate 10 and the chip 15 in order to improve the connection and reliability between the packaging substrate 10 and the chip 15. Then, the packaging substrate 10 can further electrically connect to a printed circuit board (PCB) through the ball pads 112 (located on the bottom surface 10b) and a plurality of electrically connection elements 14 (e.g. a solder ball).

Herein, the electrical connection element of the packaging substrate, which is electrically connected to the chip, can be made of solder materials, gold or copper bumps, or can be made of gold balls or copper balls. However, a proper height of the interval between the packaging substrate and the chip is needed, when a solder material used for the electrically connection element is shaped into a sphere, to enable an under-fill to be injected into the interval, thus the stresses between the packaging substrate and the chip could be reduced. Larger height necessitates a larger diameter of the sphere, thus a larger pitch (between those spheres) will occur and the electrical connection elements will be difficult to be miniaturized. If the demand of fine pitch should be reached, the diameter of the sphere should be accordingly minimal. However, the height of the connecting surface of the electrically connection elements cannot be maintained and the stress between the electrical connection elements cannot be reduced because the under-fill cannot be injected. Moreover, if metal bumps made of gold or copper are used for the electrical connection elements, the cost of the manufacture will be high.

Besides the structure mentioned above, another cylindrical structure of the conventional electrical connection elements is proposed, which is made of gold, copper, or copper alloy. However, the problem of high cost is still unsolved, and the cylindrical connection elements cannot be settled stably by using a pin attachment method.

### SUMMARY OF THE INVENTION

In order to solve the above problems, the present invention provides an electrical connection element of the packaging substrate, wherein a plurality of conductive pads and a solder mask are formed on the surface of the packaging substrate, a plurality of openings is formed in the solder mask to expose the conductive pads, and the electrically connection element is formed on the conductive pad. The electrically connection element comprises: a core layer, a first covering layer covering the core layer, and a second covering layer covering the first covering layer, in which the density of the first covering layer is higher than the density of the core layer.

According to the electrical connection element of the present invention, the shape of the electrically connection element is not limited but preferably the electrical connection element has a cylindrical shape or a spherical shape.

According to the electrical connection element of the present invention, the material of the core layer may be resin or metal having low density. Preferably, the resin may be organic resin or rubber resin. Further, the organic resin may be electric conductive resin such as organic resins having palladium, copper, silver, gold, titanium, or the combinations thereof. The rubber resin can be, for example, rubbers having fluorine or silicon. Alternatively, when the material of the core layer is a metal having low density, for example, aluminum can be used.

Besides, the first covering layer may be made of one material selected from the group consisting of: ceramics, copper, nickel/gold (gold formed after nickel), and zinc. The second covering layer, which covers the first covering layer, may be made of one material selected from the group consisting of: solder material, zinc/nickel/gold, and nickel/gold. Herein, the materials used in the first covering layer and the second covering layer depend on the material used in the core layer.

The electrical connection element of the present invention can further comprise a third covering layer covering the second covering layer. Herein, the material of the core layer may be solder material. The solder material used in the third covering layer depends on the material used in the second covering layer, and the third covering layer selectively covers the second covering layer.

Except the above electrical connection element, the present invention also provides another electrical connection element of the packaging substrate, wherein a plurality of conductive pads and a solder mask are formed on the surface of the packaging substrate, a plurality of openings is formed in the solder mask to expose the conductive pads, and the electrical connection element is formed on the conductive pad. The electrical connection element comprises: a core layer and a first covering layer, wherein the center of gravity of the electrically connection element is located in the bottom part of the electrically connection element.

Herein, according to the above electrical connection element, the shape of the electrical connection element is not limited but preferably the electrical connection element has a pear shape.

According to the above electrical connection element, the material of the core layer may be lightweight material. When lightweight material is used in the core layer, heavy material should be used in the first covering layer. Herein, the so-called lightweight material can be resin, or metal having low density. Preferably, the resin is organic resin or rubber resin. Further, for example, the organic resin can be electrically conductive resin such as organic resin having palladium, copper, silver, gold, titanium, or the combinations thereof. The rubber resin can be, for example, rubbers having fluorine or silicon. The first covering layer may be made of one material selected from the group consisting of: ceramics, copper, nickel/gold, and zinc.

Besides, the thickness of the bottom part of the first covering layer is larger than the thickness of the top part of the first covering layer.

Therefore, the electrical connection element of the packaging substrate of the present invention can solve the problem that the pitch cannot be reduced because the demand of height, and the problem that stresses occur when the under-fill cannot be injected. The present invention provides electrical connection elements that can be arranged in fine pitches, thus the miniaturization of the packaging substrate can be realized. Also, the total manufacture cost can be reduced because the cost of the material used in the electrical connection element of the present invention is not high. Meanwhile, the covering layer used herein is able to prevent the core layer from deformation. Moreover, the electrical connection element can easily stand on the packaging substrate and is suitable for applying into the fabrication of electrical connection.

### BRIEF DESCRIPTION OF THE DRAWINGS

FIG. 1 is a schematic view of a traditional flip-chip ball grid array package;

FIG. 2 is a schematic view of the packaging substrate according to a preferred example of the present invention; and

FIGS. 3 to 7 represent the electrical connection elements locating on the packaging substrates of preferred examples of the present invention.

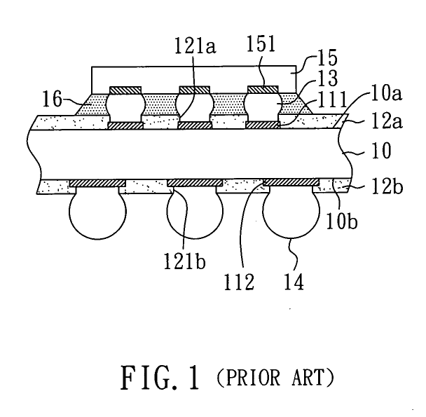

### DETAILED DESCRIPTION OF THE PREFERRED EMBODIMENT

Because of the specific embodiments illustrating the practice of the present invention, a person having ordinary skill in the art can easily understand other advantages and efficiency of the present invention through the content disclosed therein. The present invention can also be practiced or applied by other variant embodiments. Many other possible modifications and variations of any detail in the present specification based on different outlooks and applications can be made without departing from the spirit of the invention.

The drawings of the embodiments in the present invention are all simplified charts or views, and only reveal elements relative to the present invention. The elements revealed in the drawings are not necessarily aspects of the practice, and quantity and shape thereof are optionally designed. Further, the design aspect of the elements can be more complex.

### EXAMPLE 1

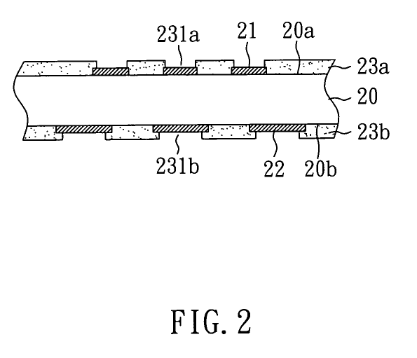

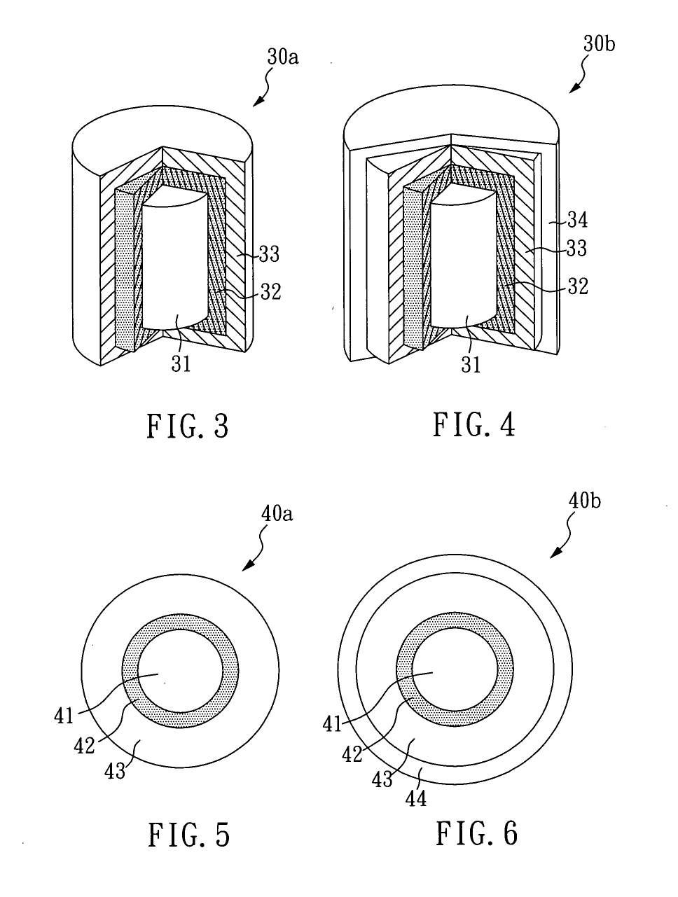

Referring to FIGS. 2 and 3, a packaging substrate of the present invention is shown in FIG. 2, and an electrical connection element 30a locating on the surface of the packaging substrate of the present invention is shown in FIG. 3.

As shown in FIG. 2, a packaging substrate 20 is provided first, wherein the packaging substrate 20 may be a circuit board. A plurality of conductive pads 21 is formed on the top surface 20a of the packaging substrate 20, and a plurality of conductive pads 22 is formed on the bottom surface 20b of the packaging substrate 20. Moreover, solder masks 23a and 23b are formed on the top surface 20a and the bottom surface 20b of the packaging substrate 20, respectively. A plurality of openings 231a and 231b is defined in the solder mask 23a and 23b respectively to expose the conductive pads 21 and 22 thereunder.

Then, an electrical connection element 30a (as shown in FIG. 3) may be provided on the conductive pads 21 locating on the top surface 20a or the conductive pads 22 locating on the bottom surface 20b of such packaging substrate 20. Herein, the electrical connection element 30a includes a core layer 31, a first covering layer 32 covering the core layer 31, and a second covering layer 33 covering the first covering layer 32, wherein the density of the first covering layer 32 is higher than the density of the core layer 31.

In the present Example 1, the electrical connection element 30a may have a cylindrical shape. Besides, the material of the core layer 31 may be a resin, or a metal having low density. Preferably, the resin is an organic resin or a rubber resin, but is not limited thereto. Further, the organic resin may be an electric conductive resin such as resins having palladium, copper, silver, gold, titanium, or the combinations thereof. The rubber resin can be, for example, rubbers having fluorine or silicon. Alternatively, when the material of the core layer 31 is a metal having low density, for example, aluminum can be used. The first covering layer 32 may be made of one material selected from the group consisting of: ceramics, copper, nickel/gold (gold formed after nickel), and zinc. The second covering layer 33, which covers the first covering layer 32, may be made of one material selected from the group consisting of: solder material, zinc/nickel/gold, and nickel/gold. The solder material used for the second covering layer 33 may be Sn, SnPb, or solder materials without Pb. Herein, the materials used in the first covering layer 32 and the second covering layer 33 depend on the material used in the core layer 31. For example, when resin is used in the core layer 31, copper or nickel/gold can be used in the first covering layer 32, and Sn, SnPb, or solder materials without Pb can be used in the second covering layer 33. Alternatively, when a metal having low density (such as aluminum) is used in the core layer 31, ceramics or zinc can be used in the first covering layer 32, and zinc/nickel/gold (zinc formed first, then nickel formed, and finally gold formed) or nickel/gold (gold formed after nickel) can be used in the second covering layer 33.

Therefore, the conductive pads 21 locating on the top surface 20a of the packaging substrate 20 are able to electrically connect to a chip (not shown) through the electrical connection elements 30a of the present invention. Besides, an under-fill 16 (not shown) can be injected to fill the interval between the packaging substrate 20 and the chip in order to improve the connection and reliability between the packaging substrate 20 and the chip, and to also release the stresses between the packaging substrate 20 and the chip.

Such electrical connection elements 30a may not only provide electrical connections between the packaging substrate 20 and the chip, but also provides electrical connections between the packaging substrate 20 and a printed circuit board (PCB) when forming on the conductive pads 22 locating on the bottom surface 20b of the packaging substrate 20. Meanwhile, the first covering layer 32 and the second covering layer 33 is able to prevent the core layer 31 from deformation.

### EXAMPLE 2

In reference to FIG. 4, except a third covering layer 34 is further provided on the surface of the second covering layer 33, the electrical connection element 30b is the same as the electrical connection element 30a of Example 1. In the present example, the material of the core layer 31 is aluminum, the material of the first covering layer 32 is zinc, the material of the second covering layer 33 is nickel/gold, and the material of the third covering layer 34 is a solder material. Accordingly, the solder material used in the third covering layer 34, for example, can be Sn, SnPb, or solder materials without Pb.

### EXAMPLE 3

In reference to FIG. 5, in particular, the electrical connection element 40a of the present example has a spherical shape instead of the cylindrical shape as in Example 1. The materials used in the core layer 41, the first covering layer 42, and the second covering layer 43 between Example 1 and the present Example 3 are the same, respectively.

### EXAMPLE 4

In reference to FIG. 6, except that a spherical shape is performed in the present example instead of a cylindrical shape, the other characters of the electrical connection element 40b of the present example are as the same as those of the electrical connection element 30b. That is, the materials of the core layer 41, the first covering layer 42, the second covering layer 43, and the third covering layer 44 are the same between Example 1 and the present Example 4 respectively.

### EXAMPLE 5

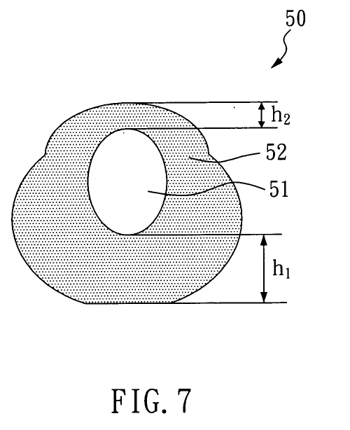

In reference to FIG. 7, generally the characters of the present example are the same as that of the Example 1, except that the electrical connection element 50 of the present example has a core layer 51 and a first covering layer 52. The first covering layer 52 covers the core layer 51, wherein the center of gravity of the electrical connection element 50 is located in the bottom part of the electrical connection element 50.

Herein, the electrical connection element may have a pear shape in the present example and the thickness of the bottom part of the first covering layer 52 (h1, ranges from the bottom edge of the core layer 51 to the bottom of the first covering layer 52) is larger than the thickness of the top part of the first covering layer 52 (h2, ranges from the top edge of the core layer 51 to the top of the first covering layer 52). The material of the core layer 51 may be light-weight materials such as resin, or metals with low density. Preferably, the resin may be organic resin or rubber resin. Moreover, the organic resin, for example, may be electrically conductive organic resin, or organic resin having palladium, copper, silver, gold, titanium, or the combinations thereof. The rubber resin, for example, may be rubber having fluorine or silicon. The core layer 51 locates in the top part of the electrical connection element 50. The material of the first covering layer 52 of the electrical connection element 50 may be heavy materials such as one selected from the group consisting of: ceramics, copper, nickel/gold, and zinc. However, when the material of the core layer 51 is resin, the first covering layer 52 may be made of copper or nickel/gold. When the material of the core layer 51 is a metal having low density such as aluminum, the first covering layer 52 may be made of ceramics or zinc.

As mentioned above, the electrical connection element locating on the packaging substrate of the present invention is a multi-layered material, and the electrical connection element of the present invention may have a cylindrical shape, a spherical shape, or a pear shape. Besides, the material of the core layer of such multi-layered material may be resin, or metal having low density, which has the advantages of reducing the material cost. When resin is used for the core layer, the stresses at the connecting surface of the electrical connection element can be reduced. Also, when the material of the core layer is metal having low density (particularly when aluminum is used), the stresses at the connecting surface of the electrical connection element can be reduced, because the properties of lightweight and soft of the material used in the core layer. Meanwhile, the covering layer made of metal, alloys, or ceramics is able to prevent the core layer from deformation. Moreover, the center of gravity of the electrical connection element is located in the bottom part of the electrical connection element, so that the electrical connection element easily stands and is suitable for applying into the fabrication of electrical connection.

Although the present invention has been explained in relation to its preferred embodiment, it is to be understood that many other possible modifications and variations can be made without departing from the scope of the invention as hereinafter claimed.

What is claimed is:

1. An electrical connection element of a packaging substrate, wherein a plurality of conductive pads and a solder mask are formed on the surface of the packaging substrate, a plurality of openings is formed in the solder mask to expose the conductive pads, and the electrical connection element is formed on the conductive pad, comprising:
a core layer;
a first covering layer covering the core layer; and
a second covering layer covering the first covering layer,
wherein the density of the first covering layer is higher than the density of the core layer.

2. The electrical connection element as claimed in claim 1, wherein the electrical connection element has a cylindrical shape, or a spherical shape.

3. The electrical connection element as claimed in claim 1, wherein the material of the core layer is resin, or metal having low density.

4. The electrical connection element as claimed in claim 3, wherein the resin is organic resin, or rubber resin.

5. The electrical connection element as claimed in claim 3, wherein the metal having low density is aluminum.

6. The electrical connection element as claimed in claim 1, wherein the first covering layer is made of one material selected from the group consisting of ceramics, copper, nickel/gold, and zinc.

7. The electrical connection element as claimed in claim 1, wherein the second covering layer is made of one material selected from the group consisting of solder material, zinc/nickel/gold, and nickel/gold.

8. The electrical connection element as claimed in claim 1, further comprising a third covering layer covering the second covering layer.

9. The electrical connection element as claimed in claim 8, wherein the third covering layer is made of solder material.

10. An electrical connection element of a packaging substrate, wherein a plurality of conductive pads and a solder mask are formed on the surface of the packaging substrate, a plurality of openings is formed in the solder mask to expose the conductive pads, and the electrical connection element is formed on the conductive pad, comprising:
a core layer; and
a first covering layer covering the core layer;
wherein the center of gravity of the electrical connection element is located in the bottom part of the electrical connection element.

11. The electrical connection element as claimed in claim 10, wherein the electrical connection element has a pear shape.

12. The electrical connection element as claimed in claim 10, wherein the material of the core layer is resin, or metal having low density.

13. The electrical connection element as claimed in claim 12, wherein the resin is organic resin, or rubber resin.

14. The electrical connection element as claimed in claim 12, wherein the metal having low density is aluminum.

15. The electrical connection element as claimed in claim 10, wherein the first covering layer is made of one material selected from the group consisting of ceramics, copper, nickel/gold, and zinc.

16. The electrical connection element as claimed in claim 10, wherein the thickness of the bottom part of the first covering layer is larger than the thickness of the top part of the first covering layer.
